(19) United States
(12) Patent Application Publication
(10) Pub. No.: US 2019/0299746 A1
(43) Pub. Date: Oct. 3, 2019

(54) VEHICLE COMPUTER TO PASSENGER CABIN HEAT TRANSFER

(71) Applicant: Ford Global Technologies, LLC, Dearborn, MI (US)

(72) Inventors: Jeffrey Yizhou Hu, Ann Arbor, MI (US); Michael Adel Awad Alla, Novi, MI (US); Kevin Fernandes, Novi, MI (US); Barnabas J. Nemec, Dearborn, MI (US)

(73) Assignee: Ford Global Technologies, LLC, Dearborn, MI (US)

(21) Appl. No.: 15/944,000

(22) Filed: Apr. 3, 2018

(51) Int. Cl. B60H 1/22; F28D 20/00; G06F 1/20

(52) U.S. Cl. CPC B60H 1/22; B60H 2001/2253; G06F 1/206; F28D 20/0056

(57) ABSTRACT

A heat transfer system includes a vehicle electronic controller, a heat sink, a housing, a controller duct and a fan. The heat sink has fins and is fixed to the controller. The housing encloses the controller and the heat sink. The controller duct connects the housing with an exhaust opening in a passenger cabin in an installed condition. The fan is in fluid communication with one of the housing and the controller duct.

### BACKGROUND

Electrical controllers for autonomous vehicles may demand a large magnitude of electrical power, e.g., over one kilowatt, to process vehicle sensor data and make driving decisions, generating heat that must be removed from the controller. Vehicles without internal combustion engines, e.g., battery electric vehicles, and vehicles that make limited use of internal combustion engines, e.g., plug-in electric hybrid vehicles, may also use electrical power to heat the passenger cabin when an ambient environmental temperature drops below a comfort threshold temperature. The electrical power used to heat the passenger cabin might otherwise be used to propel the vehicle.

### BRIEF DESCRIPTION OF THE DRAWINGS

FIG. 1 is a side view of a vehicle with a schematic diagram of a first example of a heat transfer system.

FIG. 2 is a schematic diagram of the heat transfer system of FIG. 1.

FIG. 3 is a side view of a vehicle with a schematic diagram of a second example of the heat transfer system.

FIG. 4 is a schematic diagram of the example heat transfer system of FIG. 3.

FIG. 5 is a perspective view of an example controller and controller housing of the heat transfer system of FIGS. 1-3.

FIG. 6 is a block diagram of an example vehicle incorporating a heat transfer control system.

FIG. 7 is an example flow chart of a process to direct air away from the controller.

### DETAILED DESCRIPTION

Relative orientations and directions (by way of example, upper, lower, bottom, forward, rearward, front, rear, back, outboard, inboard, inward, outward, lateral, left, right) are set forth in this description not as limitations, but for the convenience of the reader in picturing at least one example of the structures described. Such example orientations are from the perspective of an occupant seated in a seat, facing a dashboard. In the Figures, like numerals indicate like parts throughout the several views.

A heat transfer system includes a vehicle electronic controller, a heat sink, a housing, a controller duct and a fan. The heat sink has fins and is fixed to the controller. The housing encloses the controller and the heat sink. The controller duct connects the housing with an exhaust opening in a passenger cabin in an installed condition. The fan is in fluid communication with one of the housing and the controller duct.

The controller of the system may include a computing device. The computing device may include a processor and a memory. The memory may store instructions executable by the processor, the instructions comprising means to actuate the fan, determine request, and direct the air. One instruction may be to actuate the fan to direct air across the heat sink, and thereby transfer heat to the air. Another instruction may be to determine a request for an increase in air temperature in a vehicle passenger cabin. Another instruction may be to, when the request is determined, direct the air into the cabin. A further instruction may be to, when the request is not determined, direct the air to a location other than the cabin.

A vehicle includes a vehicle electronic controller, a heat sink, a housing, a controller duct, and a fan. The heat sink has fins and is fixed to the controller. The housing encloses the controller and heat sink. The controller duct connects the housing with an exhaust opening in a passenger cabin of the vehicle in an installed condition. The fan is in fluid communication with one of the housing and the controller duct.

The fins may be parallel to each other and define channels therebetween.

The exhaust opening may be defined by one of the controller duct and an HVAC duct connected to the controller duct.

The heat sink may be metal.

The system may include an air diverter valve disposed in the controller duct that in a first state directs air into the cabin and in a second state directs air elsewhere.

The controller may be disposed in a chamber located outside of the passenger cabin and is vented to receive air from outside of the vehicle.

The controller may be disposed in a trunk of the vehicle.

The system may include a supplemental heater disposed in the controller duct.

The supplemental heater may be one of a resistive heater and a liquid-to-air heat exchanger in which the liquid is coolant from an internal combustion engine.

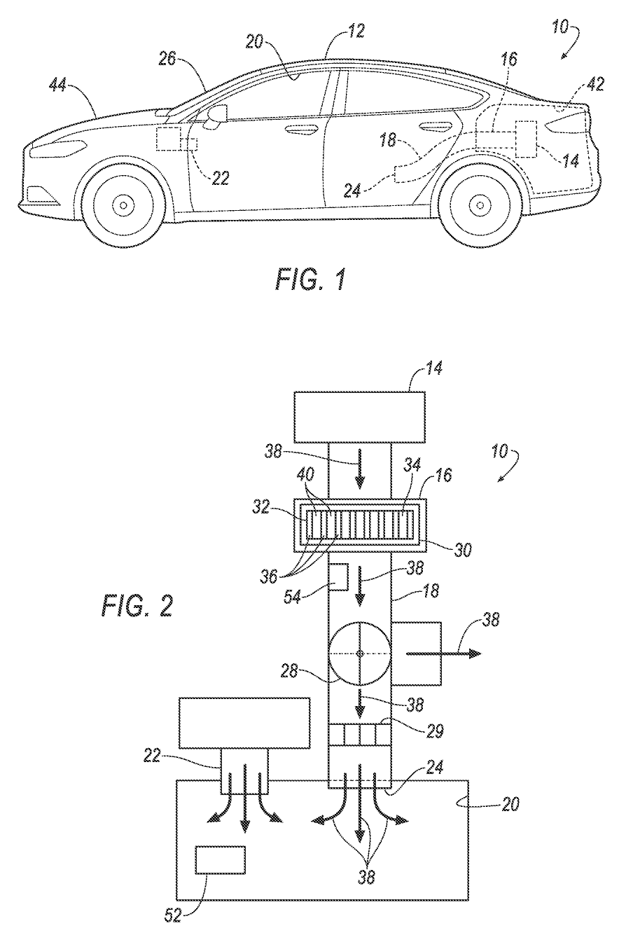

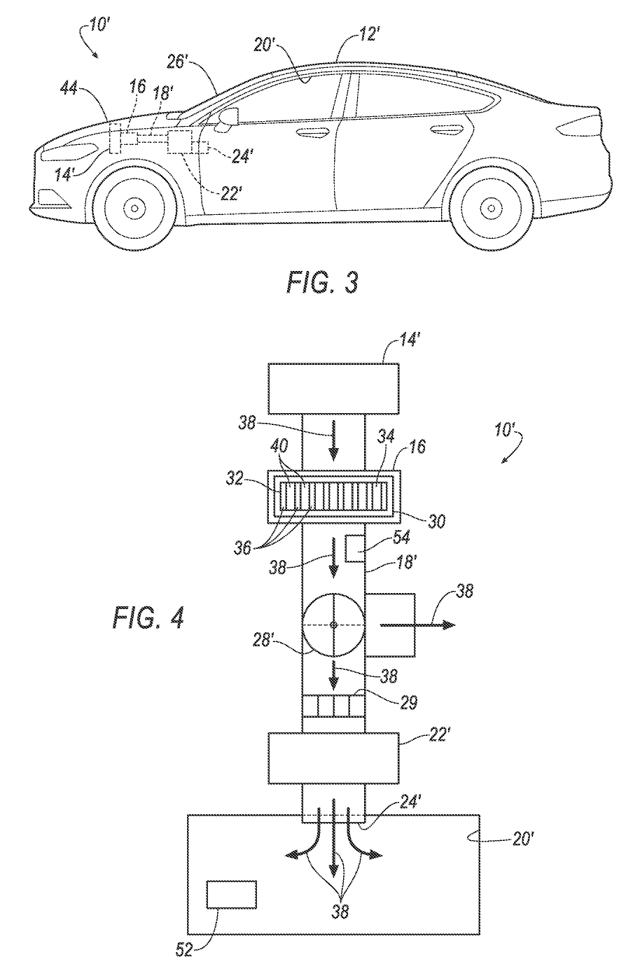

A heat transfer system 10 for a vehicle 12, examples of which are variously shown in FIGS. 1-7, include an example duct fan 14, an example controller housing 16, and an example controller duct 18 and alternative examples thereof. FIG. 1 shows a first example system 10 and the vehicle 12. FIG. 3 shows a second example system 10′ and a vehicle 12′.

The systems 10 and 10′ have commonalities, and to this extent are described together. The first example system 10 directs air from the controller housing 16 through the duct 18 and directly into a passenger cabin 20 via an exhaust opening 24 of the duct 18, in parallel with air from a separate cabin heating, ventilation and air conditioning (“HVAC”) system duct 22. The second example of the system 10′ directs air from the controller housing 16 through a controller duct 18′ into an HVAC system duct 22′ and then into a passenger cabin 20′ via an exhaust opening 24′ of the HVAC system duct 22′.

As illustrated in FIGS. 1 and 2, the heat transfer system 10 includes the duct fan 14 in fluid communication with one of the housing 16 and the controller duct 18. The fan 14 is shown on a side of the housing 16 opposite the exhaust opening 24, in a location in which the fan 14 pushes air through the housing 16. The fan 14 could alternatively be located on a side of the housing 16 connected to the duct 18, e.g., in the duct 18, with the fan 14 pulling air through the housing 16. The controller duct 18 connects the housing 16 with an exhaust opening 24 of the duct 18 in the passenger cabin 20 in an installed condition. The exhaust opening 24 may be in any one of several locations, e.g., a footwell, a middle of an instrument panel, and at a lower interior edge of a windshield 26. An air diverter valve 28 may be disposed in the controller duct 18. In a first state, schematically illustrated with a solid line, the valve 28 may direct air into the cabin 20. In a second state, schematically illustrated with a dashed line, the valve 28 may direct air elsewhere, i.e., to a location other than the cabin 20, e.g., an exterior of the vehicle 12.

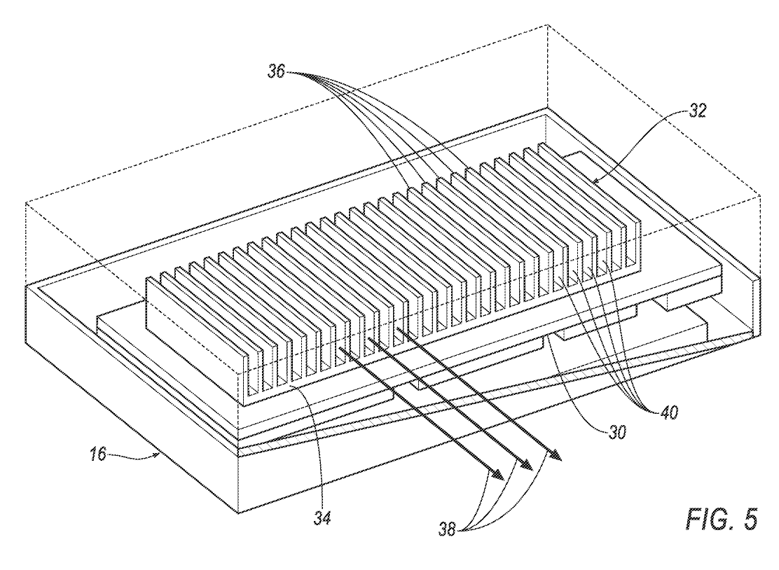

As illustrated in FIGS. 3 and 4, the second example of the heat transfer system 10′ includes a duct fan 14′ in fluid communication with one of the housing 16 and the controller duct 18′. The fan 14′ is shown in on a side of the housing opposite the controller duct 18′, in a location in which the fan 14 pushes air through the housing 16 and into the duct 18′. The fan 14′ could alternatively be located on a side of the housing 16 connected to the duct 18′, e.g., in the duct 18′, with the fan 14′ pulling air through the housing 16. The controller duct 18′ connects the housing 16 with the HVAC duct 22′ and its exhaust opening 24′ in an installed condition. The exhaust opening 24′ may be in any one of several locations, including the footwell, the middle of the instrument panel, and at the lower interior edge of a windshield 26′. An air diverter valve 28′ may be disposed in the controller duct 18′. In a first state, schematically illustrated with a solid line, the valve 28′ may direct air into the cabin 20′. In a second state, schematically illustrated with a dashed line, the valve 28′ may direct air elsewhere, i.e., to a location other than the cabin 20′, e.g., an exterior of the vehicle 12′, or alternative vehicle locations that may beneficially be heated, e.g., a battery mount area.

The controller housing 16 and its contents may be provided in the system 10 or 10′. The housing 16 encloses a vehicle electronic controller 30. The controller 30, as best shown in FIG. 5, includes a heat sink 32 with a base portion 34 and a plurality of fins 36 extending therefrom. The fins 36 may be disposed along lines substantially parallel to a direction of air flow through the housing, as represented by arrows 38, and may define parallel channels 40 therebetween. The heat sink 32, including both the base portion 34 and the fins 36, may be formed of metal (e.g., aluminum, copper). The housing 16 may be connected to the fan 14 for receipt of air therefrom. The housing 16 may be connected to the controller duct 18, 18′ for directing air to the passenger cabin 20, 20′ via the exhaust opening 24, 24′.

A supplemental heater 29 may be disposed in an air-flow path, e.g., in the controller duct 18, between the controller housing 16 and the exhaust opening 24. The heater 29 may be in the form of, for example, an electrical resistive heater, or, when the vehicle 12 includes an internal combustion engine (not shown), a liquid-to-air heat exchanger, e.g., a radiator, i.e., a heater core, receiving engine coolant from the internal combustion engine. The supplemental heater 29 may be used to heat air being directed to the cabin 20. The supplemental heater 29 may alternatively remain continuously in the path of the air flow through the duct 18 and selectively actuated, or may be placed in a secondary channel (not shown) of the duct 18 with air selectively routed through the secondary channel when supplemental heat is desired. Selective actuation of the heater 29 may be provided, in the case of an electric heater, by selectively providing electrical power to the heater 29. Selectively actuation of the liquid-to-air heat exchanger may be provided by selectively routing hot engine coolant through the heat exchanger 29.

The controller housing 16, and thus the controller 30, may be disposed in a storage chamber within the vehicle, e.g., in a trunk 42 of the vehicle 12 as illustrated in FIG. 1, or under a hood 44 of the vehicle 12′, e.g., in an engine compartment, as illustrated in FIG. 3. Such chambers 42, 44 may each be protected from the external environment to avoid direct contact of the controller housing 16 with rain and road debris. The chambers 42, 44 may be vented to receive air from outside of the vehicle 12, 12′.

For the example of FIGS. 3 and 4, the controller housing 16 may enclose the vehicle electronic controller 30 as illustrated in FIG. 5 and described above. The housing 16 may be connected to the fan 14′ for the receipt of air therefrom. The housing 16 may be connected to the controller duct 18′ for directing air to the passenger cabin 20′ via the exhaust opening 24′.

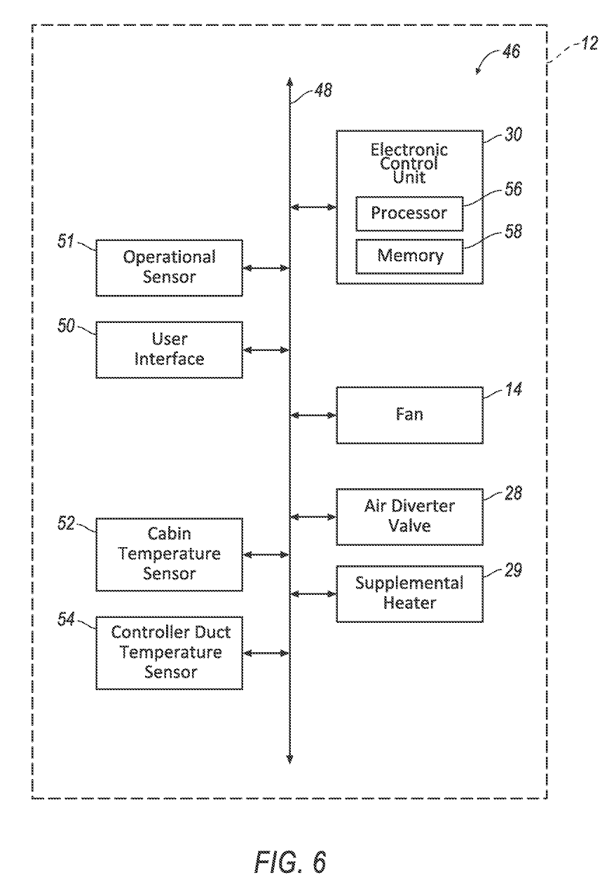

An example control system 46 for the heat transfer system 10, and also suited for use with the second example of the heat transfer system 10′, is shown schematically in FIG. 6. The control system 46 may include a vehicle network 48, a computing device, e.g., the vehicle electronic controller 30, a user interface 50 for a vehicle occupant to establish a target cabin temperature, e.g., a touch screen, or a selectively variable resistor, or an audio response system, any of which may be disposed within the cabin 20 and operated by the vehicle occupant, a plurality of sensors including an operational sensor 51, a cabin temperature sensor 52 and a duct temperature sensor 54, the supplemental heater 29, the valve 28, and the fan 14.

The vehicle network 48 may include one or more wired and/or wireless communications media such as an example system Control Area Network (“CAN”) bus or a Local Interconnect Network (“LIN”) and/or other communications media. The network 48 may provide a transmission media between and connect elements of the heat transfer system 10, 10′ including the controller 30 and components and ancillary systems including, by way of example, the user interface 50, the sensors 51, 52, 54, the fan 14, the valve 28, and the supplemental heater 29. Connections to the network 48 of the controller 30, the user interface 50, the sensors 51, 52, 54 and the fan 14, the valve 28, and the supplemental heater 29 may be made either by wire or wirelessly, as with Bluetooth® signal transmitting equipment and methods, or with other wireless signal transmission technology.

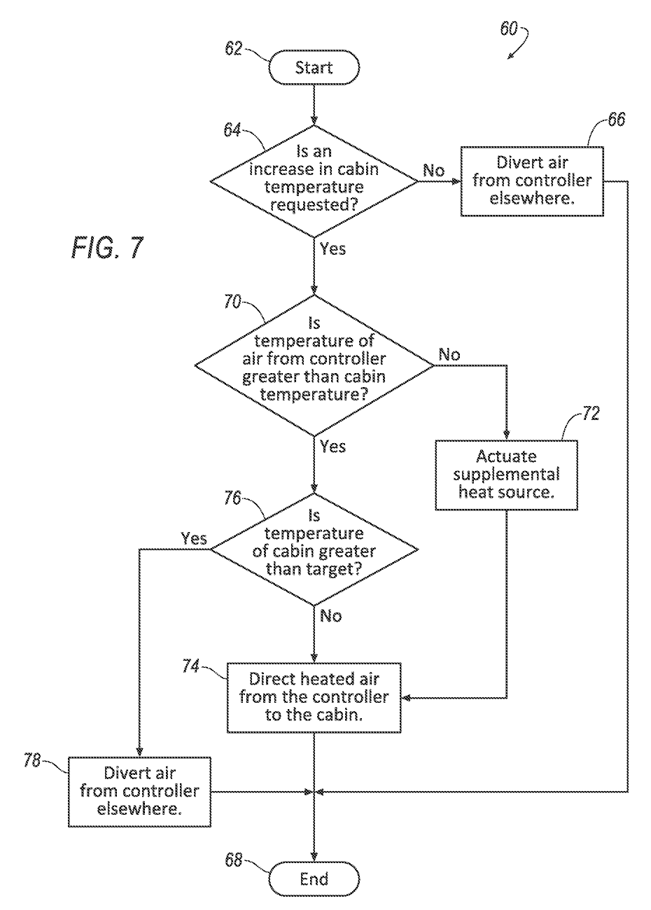

The controller 30 may be comprised of a single computing device, as shown in FIG. 1, or may alternatively be comprised of a plurality of computers (e.g., ECUs), including, for example, a powertrain computer, itself potentially comprising an engine computer and a transmission computer, an infotainment computer, a chassis systems computer, a restraint system computer, a climate control computer, a vehicle security computer, and so on. The controller 30 includes an electronic processor 56 and an associated memory 58. The control system 46, including the controller 30, is programmed to receive signals from the sensors 51, 52, 54 and to execute the exemplary logic of FIG. 7, described in more detail below.

The memory 58 of the controller 30 includes one or more forms of computer readable media, and stores instructions executable by the processor 56 for performing various operations, including such operations as disclosed herein. The processor 56 may read and execute such instructions.

The memory 58 of the controller 30 also stores data. Data may include collected data that is collected from a variety of devices including the sensors 51, 52, 54.

The temperature sensors 52, 54 may provide data by which the controller 30 can achieve a desired temperature inside of the cabin 20. Example temperature sensors 52, 54 may include, by way of example, thermocouples, thermally sensitive resistor sensors (e.g., negative temperature coefficient sensors, resistance temperature detectors), and infrared non-contact temperature sensors. The type of temperature sensor selected is not critical.

The cabin temperature sensor 52 may provide data to the controller 30 evidencing a temperature of the air in the cabin 20. The duct temperature sensor 54 may be disposed anywhere along a length of the duct 18. The duct temperature sensor 54 may provide data to the controller 30 evidencing a temperature of the air in the duct 18 from the controller housing 16.

The operational sensor 51 may provide data evidencing that the vehicle 12 is in an operational mode, i.e., a state consistent with operation, i.e., movement. Example operational sensors 51 may include an ignition switch of a car having an internal combustion engine. In a “run” position or state, the ignition switch is indicative of a readiness of the vehicle to be operated. Another example operational sensor 51 suited for an electrically powered vehicle may be a switch, however managed, used by the occupant of the vehicle to indicate a readiness to begin operation of the vehicle 12.

The fan 14 moves air from the controller housing 16 through the duct 18. The fan 14 may operate coincidentally with the controller 30, i.e., operating continuously so long as the controller is operating to keep the controller 30 from becoming too warm. Alternatively, the fan 14 may operate responsive to temperature signals from a temperature sensor (not shown) within the controller housing 16 when the temperature signals exceed a predetermined threshold. Such fan operation may be binary, i.e., either on or off, or may, alternatively, vary a rotational speed of a fan blade, i.e., a fan speed, along a spectrum between zero and a maximum sustainable fan speed.

The air diverter valve 28 may respond to command signals from the controller 30 to move between its first state and its second state. In the first state of the valve 28, substantially all the air from the fan 14 and the controller housing 16 passes through the exhaust opening 24 and into the cabin 20. In the second state of the valve, substantially all the air from the fan 14 and the controller housing 16 may be directed to a location other than the inside of the cabin 20, e.g., to an exterior of the vehicle 12. In a third state of the valve 28, a portion of the air from the fan 14 may be directed into the cabin 20, with substantially all of the rest of the air from the fan 14 being directed elsewhere, e.g., to an exterior of the vehicle 12. The portion of the air directed to the cabin 20 may vary from all of the air from the fan 14 to none of the air from the fan 14. The operation of the fan 14 and the valve 28 may be managed by the controller 30 to achieve the target temperature.

The controller 30 may include programming to determine whether to direct air from the controller 30 into the cabin 20 and whether to actuate the supplemental heater 29. FIG. 7 is a flowchart of an example process 60 incorporated by such programming that may be implemented by one or more components of the system 10. The controller 30 assesses whether there is a demand for a cabin air temperature greater than the present cabin air temperature, and further assesses whether the temperature of the air in the cabin 20 has reached the target temperature, and directing air from the controller 30 appropriately, i.e., as needed to achieve the target temperature.

A computer program for executing the process 60 may be instantiated in a start block 62, e.g., when a power-on command is issued, as may be associated with the vehicle 12 being powered up responsive to an approach or a touch by a vehicle passenger, and as indicated by the operational sensor 51.

From the start block 62, the process 60 moves to a decision block 64. The decision block 64 determines, based on data from the cabin temperature sensor 52 and the user interface 50, whether an increase in cabin temperature has been requested. When no request for an increase in cabin temperature has been determined, the process 60 moves on to a process block 66 which causes a signal to be sent by the controller 30 to the air diverter valve 28, causing the valve 28 to go to the second state, directing the heated air from the controller 30 to a location other than the cabin 20. The process 60 then may move to an end block 68. When the decision block 64 determines that an increase in cabin temperature has been requested, the process 60 moves on to a decision block 70.

The decision block 70 may determine, based on data from the duct temperature sensor 54 and from the cabin temperature sensor 52, whether a temperature of air from the controller 30 is greater than the temperature of the air in the cabin 20. When it is determined that the temperature of the air from the controller 30 is not greater than the temperature of air in the cabin 20, the decision block 70 moves on to a process block 72 that causes a signal to be sent by the controller 30 to the supplemental heater 29, actuating the supplemental heater 29. The process 60 then moves to a process block 74 that causes a signal to be sent by the controller 30 to the air diverter valve 28, causing the valve 28 to go to the first state, directing the heated air from the controller 30 to the cabin 20. The process 60 then moves to an end block 68 and terminates. When it is determined that the temperature of the air from the controller 30 is greater than the temperature of air in the cabin 20, the decision block 70 moves on to a decision block 76.

The decision block 76 may determine, based on data from cabin temperature sensor 52 and the user interface 50, whether the cabin air temperature is greater than the target temperature. When it is determined that the cabin air temperature is greater than the target temperature, the decision block 76 moves on to a process block 78 which causes a signal to be sent by the controller 30 to the air diverter valve 60, causing the valve to go to the second state, directing the heated air from the controller 30 to a location other than the cabin 20. The process 60 then moves to the end block 68 and terminates.

When it is determined by the decision block 76 that the cabin air temperature is not greater than the target temperature, the decision block 76 moves on to the process block 74 which causes a signal to be sent by the controller 30 to the air diverter valve 60, causing the valve to go to the first state, directing the heated air from the controller 30 to the cabin 20. The process 60 then moves to an end block 68 and terminates.

A heat transfer system 10, 10′ and a method for the heat transfer system 10, 10′ have been disclosed.

With regard to the references to computers including controllers in the present description, computing devices such as those discussed herein generally each include instructions executable by one or more computing devices such as those identified above, and for carrying out blocks or steps of processes described above. For example, process blocks discussed above are embodied as computer executable instructions.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems, and the Argo AI system for autonomous vehicle operation. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A heat transfer system comprising:
a vehicle electronic controller;
a heat sink with fins, fixed to the controller;
a housing enclosing the controller and heat sink;
a controller duct connecting the housing with an exhaust opening in a passenger cabin in an installed condition; and
a fan in fluid communication with one of the housing and the controller duct.

2. The system of claim 1 wherein the fins are parallel to each other and define channels therebetween.

3. The system of claim 1 with the exhaust opening defined by one of the controller duct and an HVAC duct connected to the controller duct.

4. The system of claim 1, wherein the heat sink is metal.

5. The system of claim 1, further comprising an air diverter valve disposed in the controller duct that in a first state directs air into the cabin and in a second state directs air elsewhere.

6. The system of claim 1, wherein the controller is disposed in a chamber located outside of the passenger cabin and is vented to receive air from outside of the vehicle.

7. The system of claim 1, wherein the controller is disposed in a trunk of the vehicle.

8. The system of claim 1 further comprising a supplemental heater disposed in the controller duct.

9. The system of claim 8, in which the supplemental heater is one of a resistive heater and a liquid-to-air heat exchanger in which the liquid is coolant from an internal combustion engine.

10. The system of claim 1, wherein the controller comprises a computing device that includes a processor and a memory, the memory storing instructions executable by the processor comprising means for:
actuating the fan to direct air across the heat sink, and thereby transfer heat to the air;
determining a request for an increase in air temperature in the passenger cabin;
when the request is determined, directing the air into the cabin; and
when the request is not determined, directing the air to a location other than the cabin.

11. A vehicle comprising:
a vehicle electronic controller;
a heat sink with fins, fixed to the controller;
a housing enclosing the controller and heat sink;
a controller duct connecting the housing with an exhaust opening in a passenger cabin of the vehicle in an installed condition; and
a fan in fluid communication with one of the housing and the controller duct.

12. The vehicle of claim 11 wherein the fins are parallel to each other and define channels therebetween.

13. The vehicle of claim 11 with the exhaust opening defined by one of the controller duct and an HVAC duct connected to the controller duct.

14. The vehicle of claim 11, wherein the heat sink is metal.

15. The vehicle of claim 11, further comprising an air diverter valve disposed in the controller duct that in a first state directs air into the cabin and in a second state directs air elsewhere.

16. The vehicle of claim 11, wherein the controller is disposed in a chamber located outside of the passenger cabin and is vented to receive air from outside of the vehicle.

17. The vehicle of claim 11, wherein the controller is disposed in a trunk of the vehicle.

18. The vehicle of claim 11 further comprising a supplemental heater disposed in the controller duct.

19. The vehicle of claim 18, in which the supplemental heater is one of a resistive heater and a liquid-to-air heat exchanger in which the liquid is coolant from an internal combustion engine.

20. The vehicle of claim 11, wherein the controller comprises a computing device that includes a processor and a memory, the memory storing instructions executable by the processor comprising means for:
actuating the fan to direct air across the heat sink, and thereby transfer heat to the air;
determining a request for an increase in air temperature in the passenger cabin;
when the request is determined, directing the air into the cabin; and
when the request is not determined, directing the air to a location other than the cabin.
